(19) United States
(12) Patent Application Publication
(10) Pub. No.: US 2024/0359265 A1
(43) Pub. Date: Oct. 31, 2024

(54) APPARATUS AND METHOD OF MANUFACTURING SEMICONDUCTOR DEVICE

(71) Applicant: Mitsubishi Electric Corporation, Tokyo (JP)

(72) Inventors: Shinji KOGA, Tokyo (JP); Jun TABARA, Tokyo (JP)

(73) Assignee: Mitsubishi Electric Corporation, Tokyo (JP)

(21) Appl. No.: 18/414,233

(22) Filed: Jan. 16, 2024

(30) Foreign Application Priority Data
Apr. 28, 2023 (JP) 2023-073949

(51) Int. Cl. B23K 26/362; B23K 26/03; B23K 26/06; B23K 26/08; B23K 26/70; B23K 101/40

(52) U.S. Cl. CPC B23K 26/362; B23K 26/032; B23K 26/0648; B23K 26/0823; B23K 26/0861; B23K 26/705; B23K 2101/40

(57) ABSTRACT

The object is to provide a technology capable of appropriately removing polycrystalline protrusions. A manufacturing apparatus for a semiconductor device includes: a laser oscillation device configured to irradiate a second main surface of a semiconductor component disposed on a stage with a first laser light and a second laser light higher in output than the first laser light; a scattered light detector to detect scattered light scattered by protrusions in the first laser light; and a laser controller to cause the laser oscillation device to irradiate the protrusions with the second laser light, based on a detection result of the scattered light detector.

### BACKGROUND OF THE INVENTION

### Field of the Invention

The present disclosure relates to an apparatus and a method of manufacturing a semiconductor device.

### Description of the Background Art

When an epitaxial layer is formed on a monocrystalline silicon carbide (SiC) wafer, polycrystalline protrusions causing, for example, a fracture in the SiC wafer are sometimes formed on a surface of the SiC wafer other than the surface on which the epitaxial layer is formed. To address this, for example, Japanese Patent Application Laid-Open No. 2021-70617 proposes a technology for removing protrusions by irradiating, with a laser light, a whole surface on which the protrusions are formed, using a difference in absorption coefficient between laser lights which is caused by a difference in crystallinity.

Under such conventional technologies, however, the protrusions are removed by not detecting the protrusions but relying on only the difference in absorption coefficient between laser lights which is caused by the difference in crystallinity. Thus, the laser lights cannot be controlled based on the presence or absence or the size of the protrusions. This causes a problem of incomplete removal of protrusions, and a problem of damaging a semiconductor substrate by a laser light, for example, having a recess on the semiconductor substrate.

### SUMMARY

The present disclosure has been conceived in view of the problems, and the object is to provide a technology capable of appropriately removing polycrystalline protrusions.

A manufacturing apparatus for a semiconductor device according to the present disclosure includes: a stage on which a semiconductor component is disposed with at least a part of a second main surface being exposed, the semiconductor component including a semiconductor substrate and an epitaxial layer on the semiconductor substrate, and having a first main surface of the epitaxial layer opposite to the semiconductor substrate, and the second main surface of the semiconductor substrate opposite to the epitaxial layer; a laser oscillation device configured to irradiate the second main surface of the semiconductor component disposed on the stage with a first laser light and a second laser light higher in output than the first laser light; a scattered light detector to detect scattered light scattered by a polycrystalline protrusion in the first laser light when the second main surface of the semiconductor component has the protrusion; and a laser controller to cause the laser oscillation device to irradiate the protrusion with the second laser light, based on a detection result of the scattered light detector.

Polycrystalline protrusions can be appropriately removed.

These and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a structure of a manufacturing apparatus for a semiconductor device according to Embodiment 1;

FIG. 2 is a schematic diagram illustrating the structure of the manufacturing apparatus for the semiconductor device according to Embodiment 1;

FIG. 3 is a schematic diagram illustrating the structure of the manufacturing apparatus for the semiconductor device according to Embodiment 1;

FIG. 4 is a schematic diagram illustrating a structure of a manufacturing apparatus for a semiconductor device according to Embodiment 2;

FIG. 5 is a schematic diagram illustrating a structure of a manufacturing apparatus for a semiconductor device according to Embodiment 3;

FIG. 6 is a schematic diagram illustrating a structure of a manufacturing apparatus for a semiconductor device according to Embodiment 4;

FIG. 7 is a perspective view schematically illustrating a semiconductor component according to Embodiment 4; and

FIG. 8 is a schematic diagram illustrating a structure of a manufacturing apparatus for a semiconductor device according to Embodiment 5.

### DESCRIPTION OF THE PREFERRED EMBODIMENTS

Embodiments will be hereinafter described with reference to the attached drawings. The features to be described in Embodiments below are exemplifications, and all of the features are not necessarily essential. In the description below, identical constituent elements in a plurality of Embodiments will be denoted by the same or similar reference numerals, and the different constituent elements will be mainly described. In the following description, a particular position and a particular direction such as “up”, “down”, “left”, “right”, “front”, or “back” need not always coincide with an actual position and an actual direction.

### Embodiment 1

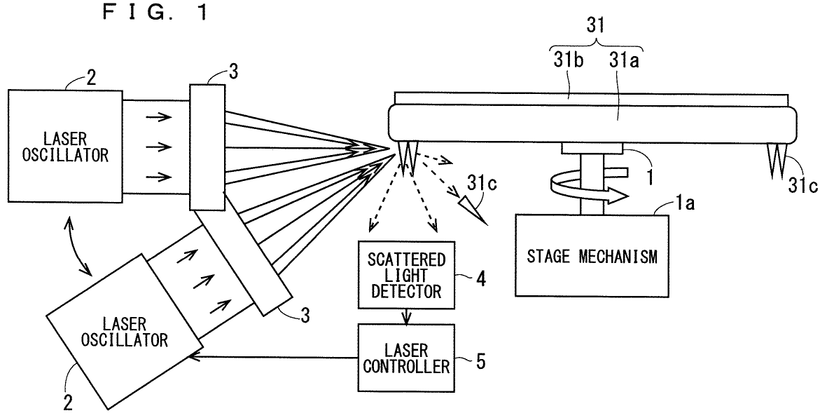

FIG. 1 is a schematic diagram illustrating a structure of a manufacturing apparatus for a semiconductor device according to Embodiment 1. The manufacturing apparatus in FIG. 1 is an apparatus that processes a semiconductor component 31.

The semiconductor component 31 includes a SiC wafer 31a that is a semiconductor substrate, and an epitaxial layer 31b provided on the SiC wafer 31a. The semiconductor component 31 has an upper surface that is a first main surface of the epitaxial layer 31b opposite to the SiC wafer 31a, and a lower surface that is a second main surface of the SiC wafer 31a opposite to the epitaxial layer 31b. When the epitaxial layer 31b is formed on the upper surface of the SiC wafer 31a, the lower surface of the SiC wafer 31a, that is, the lower surface of the semiconductor component 31 sometimes has protrusions 31c made of polycrystalline SiC due to abnormal growth.

In Embodiment 1, the lower surface of the semiconductor component 31 is a c-face of the SiC wafer 31a, that is, a carbon face. In a crystalline structure of SiC, a surface with a top surface made of Si is referred to as a silicon face, and a surface with a top surface made of C is referred to as a carbon face. The carbon face is prone to combine with C because of having the same C on the top surface, and the protrusions 31c tend to be formed on the carbon face, depending on a growth gas.

The manufacturing apparatus in FIG. 1 includes a stage 1, one laser oscillator 2, a lens 3, a scattered light detector 4, and a laser controller 5. FIG. 1 illustrates positions of the laser oscillator 2 before and after the movement.

The semiconductor component 31 is disposed on the stage 1 with at least a part of the lower surface of the semiconductor component 31 being exposed. The stage 1 can perform translational motion in the x, y, and z directions and rotate in a θ direction corresponding to a circumferential direction of the semiconductor component 31, together with the disposed semiconductor component 31. A stage mechanism 1a causes the stage 1 to perform the translational motion and rotate.

The laser oscillator 2 is a laser oscillation device configured to irradiate the lower surface of the semiconductor component 31 disposed on the stage 1 with a first laser light and a second laser light higher in output than the first laser light. In Embodiment 1, the first laser light is used for detecting the protrusions 31c, and the second laser light is used for removing the protrusions 31c.

The laser oscillator 2 is configured to irradiate the lower surface of the SiC wafer 31a selectively with the first laser light and the second laser light, in an angle range of angles at which quantities of the first laser light and the second laser light entering the semiconductor component 31 from the lower surface of the SiC wafer 31a are lower than or equal to a predefined value. The angle range herein is, for example, a range in which the quantity of each of the laser lights entering the semiconductor component 31 is lower than or equal to the predefined value, the range being from an angle where the traveling direction of each laser beam is parallel to the lower surface of the SiC wafer 31a to an angle where the traveling direction is inclined with the lower surface.

The lens 3 collects the laser light emitted from the laser oscillator 2. The lens 3 is movable together with the laser oscillator 2.

The scattered light detector 4 detects scattered light scattered by the protrusions 31c in the first laser light, when the lower surface of the semiconductor component 31 has the protrusions 31c. The scattered light detector 4 is located in a direction of detecting neither light directly incident from the lens 3 or light reflected from the lower surface of the semiconductor component 31 without the protrusions 31c in the first laser light (e.g., a direction of 90 degrees with respect to the lower surface of the SiC wafer 31a).

The laser controller 5 performs signal processing based on a detection result of the scattered light detector 4 to identify, for example, positions of the protrusions 31c and cause the laser oscillator 2 to irradiate the protrusions 31c with the second laser light. This removes the protrusions 31c from the SiC wafer 31a.

Here, a semiconductor device which can stably operate at high temperatures and high voltages and in which switching speeds can be accelerated can be formed from the SiC wafer 31a. 4H SiC wafers are often used for generating semiconductor devices for power devices. The SiC wafer 31a may be a 4H monocrystalline SiC wafer, a 6H monocrystalline SiC wafer, or a SiC wafer with crystals of another type. In contrast, the protrusions 31c contain polycrystalline SiC.

When the SiC wafer 31a is a 4H monocrystalline SiC wafer, a wavelength better absorbed by polycrystalline SiC than by 4H monocrystalline SiC or a wavelength whose penetration length to the SiC wafer 31a is shorter is selected as a wavelength of the second laser light to be used for removing the protrusions 31c. For example, the second laser light has a wavelength lower than or equal to 600 nm, preferably, a wavelength lower than or equal to 532 nm. In Embodiment 1, a third harmonic of a YAG laser at 355 nm is used as the wavelength of the second laser light. The light energy of the second laser light is 3.5 eV. Thus, the second laser light can produce the light energy high enough to process SiC with a band gap of 3.26 V. The conditions of the second laser light described herein are examples. The conditions of the second laser light should be selected according to the protrusions 31c.

### [Operations]

In the manufacturing apparatus with such a structure, the laser oscillator 2 horizontally or diagonally irradiates the lower surface of the SiC wafer 31a with the first laser light of a low output. The angle at which the laser oscillator 2 diagonally irradiates the lower surface with the first laser light is preferably an angle at which the quantity of light entering the SiC wafer 31a is the smallest, because the laser light entering SiC of a refractive index of 2.6 from the air of a refractive index of 1.0 has no wavelength at which light is totally reflected.

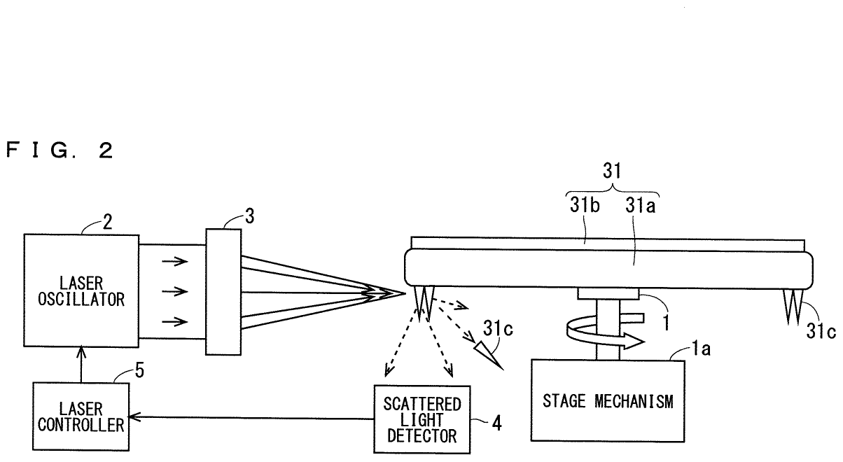

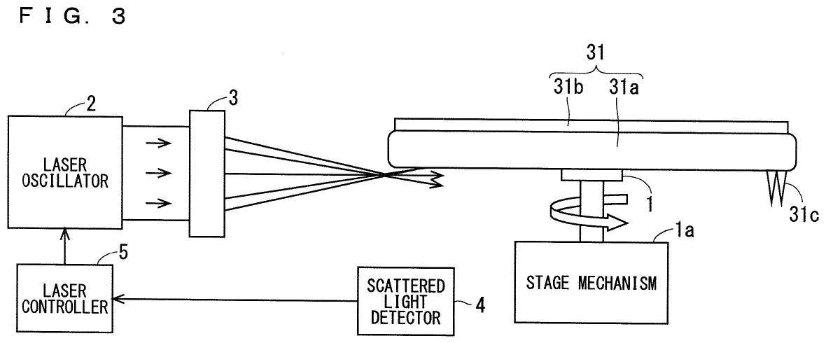

The scattered light detector 4 detects scattered light scattered by the protrusions 31c in the first laser light, when the lower surface of the semiconductor component 31 has the protrusions 31c. As illustrated in FIG. 2, the scattered light detector 4 detects the scattered light when the lower surface of the SiC wafer 31a has the protrusions 31c. When the lower surface of the SiC wafer 31a does not have the protrusions 31c, the scattered light detector 4 does not detect scattered light as illustrated in FIG. 3. Thus, the detection result of the scattered light detector 4 can determine the presence or absence of the protrusions 31c, and whether the protrusions 31c have been removed by irradiation of the second laser light.

After the scattered light detector 4 has detected the scattered light, the laser controller 5 switches the laser light irradiated by the laser oscillator 2 from the first laser light to the second laser light, and causes the laser oscillator 2 to irradiate a position (e.g., coordinates) at which the scattered light has been detected with the second laser light of a high output. Consequently, the protrusions 31c sublime or fall, and are removed.

### [Manufacturing Method]

A method of manufacturing a semiconductor device using the aforementioned manufacturing apparatus includes a growth step of growing the epitaxial layer 31b on the upper surface of the SiC wafer 31a, a transporting step of disposing the semiconductor component 31 on the stage 1, and a removal step of detecting and removing the protrusions 31c.

### [Growth Step]

In the growth step, for example, a silane-based gas such as mono-silane and a hydrocarbon-based gas such as propane are introduced as growth gases, and a gas containing nitrogen or a gas containing an element to be an n-type dopant for silicon carbide is introduced as a dopant gas. This grows the epitaxial layer 31b on the upper surface of the SiC wafer 31a to form the semiconductor component 31. The growth gases surround the lower surface of the SiC wafer 31a. As a result, this sometimes creates the protrusions 31c three-dimensionally grown on the lower surface and containing polycrystalline SiC. Particularly, the protrusions 31c tend to be formed around a perimeter of the lower surface of the SiC wafer 31a.

Normal SiC wafers 31a have diameters ranging from 100 mm to 150 mm and thicknesses ranging from 350 μm to 600 μm. As the diameter of the SiC wafer 31a is increased to 8 inches and further to 12 inches, an area on which the protrusions 31c are formed widens. Thus, as the diameter of the SiC wafer 31a is increased, the manufacturing apparatus according to Embodiment 1 is more useful for removing the protrusions 31c.

### [Transporting Step]

In the transporting step, a transporting mechanism that is not illustrated transports the semiconductor component 31 to dispose the semiconductor component 31 on the stage 1 with at least a part of the lower surface of the semiconductor component 31 being exposed.

### [Removal Step]

In the removal step, the laser oscillator 2 irradiates, in the aforementioned angle range, the lower surface of the semiconductor component 31, that is, the lower surface of the SiC wafer 31a with the first laser light of a low output. In Embodiment 1, the laser oscillator 2 irradiates the perimeter around the lower surface of the semiconductor component 31 with the first laser light, while the lower surface of the SiC wafer 31a is disposed on the stage 1 and the stage mechanism 1a causes the stage 1 to rotate. Then, the scattered light detector 4 detects the presence or absence of the scattered light. In the absence of the protrusions 31c, the scattered light detector 4 does not detect scattered light. In the presence of the protrusions 31c, the scattered light detector 4 detects the scattered light.

The laser controller 5 generates position information on the protrusions 31c based on the detection result of the scattered light detector 4 and rotation information on the stage mechanism 1a for the stage 1, and causes the laser oscillator 2 to irradiate the protrusions 31c with the second laser light of a high output, based on the position information. This can prevent the SiC wafer 31a from being damaged such as having a recess, and make the protrusions 31c sublime or fall, and be removed.

### [Other Steps]

After the removal step, for example, implanting ions into the semiconductor component 31 or etching the semiconductor component 31 forms semiconductor elements in the semiconductor component 31, thus completing a semiconductor device. Examples of the semiconductor elements to be formed in the semiconductor component 31 include power semiconductor elements such as diode elements and switching elements. Examples of the diode elements include a Schottky barrier diode (SBD) and a PN junction diode (PND). Examples of the switching elements include a metal-oxide semiconductor field-effect transistor (MOSFET), an insulated-gate bipolar transistor (IGBT), and a reverse conducting IGBT (RC-IGBT).

### Conclusion of Embodiment 1

The manufacturing apparatus for the semiconductor device according to Embodiment 1 detects the protrusions 31c using the scattered light of the first laser light of the low output, and irradiates the detected protrusions 31c with the second laser light of the high output. With such a structure, the manufacturing apparatus can irradiate the protrusions 31c with the second laser light, while confirming whether the protrusions 31c have been removed. This can prevent incomplete removal of the protrusions 31c and damaging the SiC wafer 31a, and efficiently and appropriately remove the protrusions 31c.

The laser oscillator 2 according to Embodiment 1 irradiates the lower surface of the SiC wafer 31a selectively with the first laser light and the second laser light, in an angle range of angles at which quantities of the first laser light and the second laser light entering the semiconductor component 31 from the lower surface of the SiC wafer 31a are lower than or equal to a predefined value. Such a structure can prevent damaging the SiC wafer 31a. Furthermore, application of the single laser oscillator 2 facilitates aligning an irradiating position of the first laser light and an irradiating position of the second laser light.

The scattered light detector 4 according to Embodiment 1 does not detect the light reflected from the lower surface of the semiconductor component 31 without the protrusions 31c in the first laser light. Such a structure can increase the accuracy of detecting the protrusions 31c.

In Embodiment 1, the lower surface of the semiconductor component 31 is a c-face of the SiC wafer 31a. Since the protrusions 31c are easily formed on the lower surface of the semiconductor component 31 in this case, the advantages of the manufacturing apparatus for the semiconductor device according to Embodiment 1 are particularly useful.

### Embodiment 2

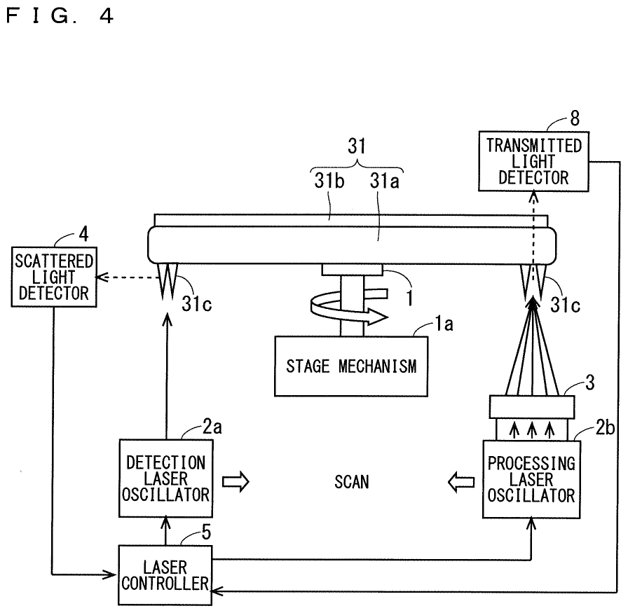

FIG. 4 is a schematic diagram illustrating a structure of a manufacturing apparatus for a semiconductor device according to Embodiment 2. The laser oscillation device according to Embodiment 1 is the single laser oscillator 2 that irradiates an object selectively with the first laser light and the second laser light.

In contrast, a laser oscillation device according to Embodiment 2 includes a detection laser oscillator 2a as a first laser oscillator configured to irradiate the lower surface of the semiconductor component 31 with the first laser light, and a processing laser oscillator 2b as a second laser oscillator configured to irradiate the protrusions 31c with the second laser light. The processing laser oscillator 2b is configured to irradiate the protrusions 31c with the second laser light, in parallel with irradiation of the first laser light by the detection laser oscillator 2a.

In the example of FIG. 4, the detection laser oscillator 2a and the processing laser oscillator 2b are arranged to face the perimeter of the lower surface of the SiC wafer 31a and sandwich the stage 1. The positions of the detection laser oscillator 2a and the processing laser oscillator 2b are not limited to those in FIG. 4.

The stage 1 and the lens 3 according to Embodiment 2 are identical to those according to Embodiment 1. The scattered light detector 4 according to Embodiment 2 detects scattered light scattered by the protrusions 31c in the first laser light, when the lower surface of the semiconductor component 31 has the protrusions 31c, similarly to the scattered light detector 4 according to Embodiment 1.

The manufacturing apparatus according to Embodiment 2 includes a transmitted light detector 8. The transmitted light detector 8 detects transmitted light that has transmitted the semiconductor component 31 in the second laser light irradiated from the processing laser oscillator 2b.

The laser controller 5 changes outputs of the first laser light from the detection laser oscillator 2a and the second laser light from the processing laser oscillator 2b, based on the detection result of the scattered light detector 4 and a detection result of the transmitted light detector 8, respectively. The laser controller 5 changes the outputs of the respective laser lights, for example, by changing the energy and the repetition frequency of unit pulses of each of the laser lights based on the detection result of the scattered light detector 4 and the detection result of the transmitted light detector 8. The energy and the repetition frequency of unit pulse of the first laser light from the detection laser oscillator 2a are preferably reduced as much as possible to the extent that the protrusions 31c can be detected. The energy and the repetition frequency of unit pulse of the second laser light from the processing laser oscillator 2b are preferably increased as much as possible to the extent that the SiC wafer 31a is not damaged.

### Conclusion of Embodiment 2

The manufacturing apparatus for the semiconductor device according to Embodiment 2 detects the protrusions 31c using the scattered light of the first laser light of the low output, and irradiates the detected protrusions 31c with the second laser light of the high output. This structure can efficiently and appropriately remove the protrusions 31c, similarly to Embodiment 1.

The processing laser oscillator 2b according to Embodiment 2 is configured to irradiate the protrusions 31c with the second laser light, in parallel with irradiation of the first laser light by the detection laser oscillator 2a. This structure can simultaneously detect and remove the protrusions 31c without switching between the first laser light and the second laser light. Thus, the processing time can be shortened.

The laser controller 5 according to Embodiment 2 changes outputs of the first laser light of the detection laser oscillator 2a and the second laser light of the processing laser oscillator 2b, based on the detection result of the scattered light detector 4 and the detection result of the transmitted light detector 8. Such a structure can increase the redundancy for detecting the protrusions 31c and consequently optimize the outputs of the first laser light and the second laser light. Since the laser controller 5 can appropriately change the output of the second laser light, for example, according to an in-progress state of removing the protrusions 31c, the accuracy of removing the protrusions 31c can be increased.

### Embodiment 3

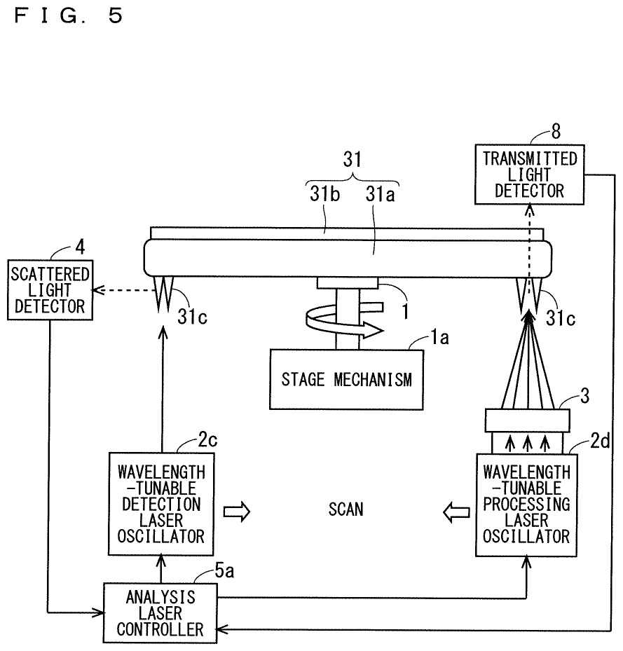

FIG. 5 is a schematic diagram illustrating a structure of a manufacturing apparatus for a semiconductor device according to Embodiment 3. The structure in FIG. 5 is obtained by replacing the detection laser oscillator 2a, the processing laser oscillator 2b, and the laser controller 5 in FIG. 4 with a wavelength-tunable detection laser oscillator 2c, a wavelength-tunable processing laser oscillator 2d, and an analysis laser controller 5a, respectively.

The wavelength-tunable detection laser oscillator 2c is configured to change the wavelength of the first laser light, and the wavelength-tunable processing laser oscillator 2d is configured to change the wavelength of the second laser light. The analysis laser controller 5a performs multivariate analysis on the detection result of the scattered light detector 4 and the detection result of the transmitted light detector 8 for each of the wavelengths to identify at least one of a size, a shape, or a crystalline state of the protrusions 31c. In this Description, at least one of A, B, C, . . . , or Z means any one of all combinations obtained by combining one or more combinations extracted from each of groups of A, B, C, . . . , and Z. Then, the analysis laser controller 5a changes the wavelength and the output of the second laser light of the wavelength-tunable processing laser oscillator 2d, based on the identified result of the protrusions 31c.

### Conclusion of Embodiment 3

The manufacturing apparatus for the semiconductor device according to Embodiment 3 performs multivariate analysis on the detection result of the scattered light detector 4 and the detection result of the transmitted light detector 8 for each of the wavelengths to identify at least one of a size, a shape, or a crystalline state of the protrusions 31c. Such a structure can detect an in-progress state of removing the protrusions 31c with high accuracy. Since the analysis laser controller 5a can appropriately change the wavelength and the output of the second laser light according to the in-progress state of removing the protrusions 31c, the accuracy of removing the protrusions 31c can be increased. For example, application of a wavelength at which, for example, scattered light, reflected light, and transmitted light are smaller as much as possible, that is, a wavelength at which a laser absorption coefficient of the protrusions 31c is high to the wavelength of the second laser light can shorten the time to remove the protrusions 31c.

### [Modifications]

Although Embodiment 3 describes application of Embodiment 2, Embodiment 3 is not limited to this. For example, Embodiment 3 is applicable to the manufacturing apparatus according to Embodiment 1 to which the transmitted light detector 8 is added and in which the laser oscillator 2 has a laser light wavelength-tunable function and the laser controller 5 is replaced with the analysis laser controller 5a.

### Embodiment 4

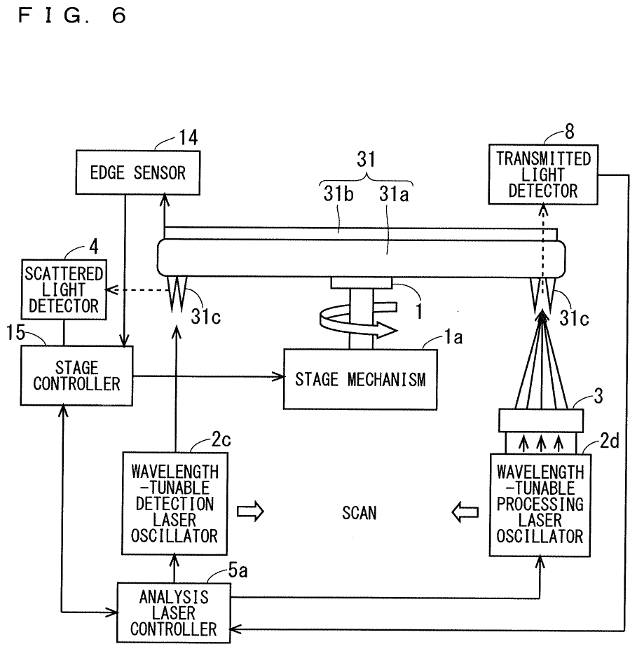

FIG. 6 is a schematic diagram illustrating a structure of a manufacturing apparatus for a semiconductor device according to Embodiment 4. The structure in FIG. 6 is obtained by adding an edge sensor 14 and a stage controller 15 to the structure in FIG. 5.

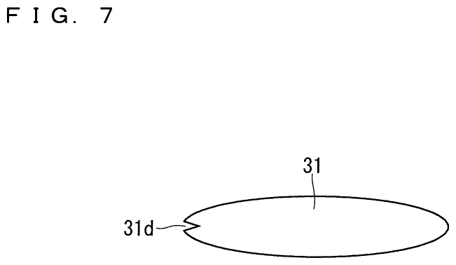

As illustrated in FIG. 7, the semiconductor component 31 according to Embodiment 4 is provided with a notch 31d to be used as a reference for the semiconductor component 31. The edge sensor 14 in FIG. 6 has a function of detecting a notch. While the semiconductor component 31 is disposed on the stage 1, the edge sensor 14 detects the notch 31d provided on the semiconductor component 31, and an edge that is an outer edge of the semiconductor component 31. The stage controller 15 controls the translational motion and the rotation of the stage 1 on which the semiconductor component 31 is disposed, based on a detection result of the edge sensor 14.

For example, while the stage controller 15 rotates, for example, the semiconductor component 31 in the θ direction, the edge sensor 14 detects the position of the notch 31d and the position of the edge of the semiconductor component 31, based on the reflected light or the transmitted light obtained by irradiating the edge of the semiconductor component 31 with light. Then, the edge sensor 14 detects the position of the center of the semiconductor component 31 based on the position of the notch 31d and the position of the edge. The stage controller 15 aligns the stage 1 and the semiconductor component 31 to cause the stage 1 and the semiconductor component 31 to perform the translational motion and rotate, based on the position of the notch 31d and the position of the center of the semiconductor component 31.

### Conclusion of Embodiment 4

The manufacturing apparatus for the semiconductor device according to Embodiment 4 controls the translational motion and the rotation of the stage 1 on which the semiconductor component 31 is disposed, based on a detection result of the edge sensor 14. Since such a structure can align the semiconductor component 31 to a desired position with high accuracy, the irradiating position of the second laser light can be aligned with each of the positions of the protrusions 31c on the semiconductor component 31. This can consequently prevent irradiation of the second laser light to a portion of the semiconductor component 31 without the protrusions 31c. Thus, damaging the SiC wafer 31a can be prevented.

### [Modifications]

Although Embodiment 4 describes application of Embodiment 3, Embodiment 4 is not limited to this. Embodiment 4 is applicable to, for example, Embodiments 1 and 2.

### Embodiment 5

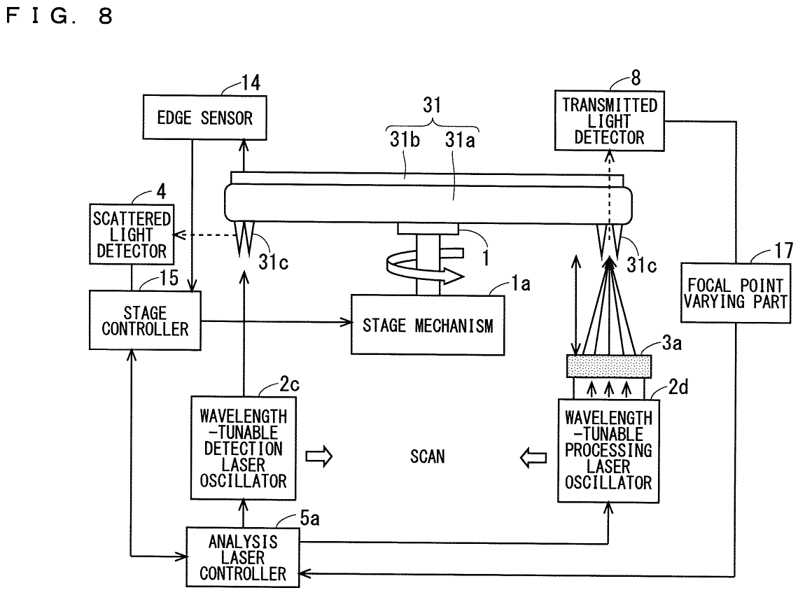

FIG. 8 is a schematic diagram illustrating a structure of a manufacturing apparatus for a semiconductor device according to Embodiment 5. The structure in FIG. 8 is obtained by replacing the lens 3 with a high numerical aperture (NA) lens 3a and adding a focal point varying part 17 to the structure in FIG. 6.

The high numerical aperture lens 3a is one lens selected from among a plurality of lenses with different numerical apertures, and has, for example, a numerical aperture higher than that of the lens 3. The high numerical aperture lens 3a is selected so that the numerical aperture of the high numerical aperture lens 3a increases as the size of the protrusions 31c in a plan view is smaller. For example, when the high numerical aperture lens 3a with a numerical aperture of 0.6 is selected and light is collected to the protrusions 31c at a laser wavelength of 355 nm, the high numerical aperture lens 3a can obtain a focused spot diameter of approximately 1 μm.

The user may manually select and set the high numerical aperture lens 3a. Alternatively, the manufacturing apparatus may calculate the size of the protrusions 31c based on at least one of the detection result of the scattered light detector 4 or the detection result of the transmitted light detector 8, and select and set the high numerical aperture lens 3a based on the size.

The wavelength-tunable processing laser oscillator 2d irradiates the protrusions 31c with the second laser light through the selected high numerical aperture lens 3a. The focal point varying part 17 calculates a height of the protrusions 31c based on at least one of the detection result of the scattered light detector 4 or the detection result of the transmitted light detector 8, and varies a focal length of the high numerical aperture lens 3a to be used for irradiation of the second laser light based on the height. For example, the focal point varying part 17 shortens the focal length of the high numerical aperture lens 3a as the protrusions 31c are higher. The protrusions 31c are often lower than or equal to 20 μm.

### Conclusion of Embodiment 5

The manufacturing apparatus for the semiconductor device according to Embodiment 5 irradiates the protrusions 31c with the second laser light through one lens selected from among a plurality of lenses with different numerical apertures, and varies a focal length of the lens to be used for irradiation of the second laser light based on at least one of the detection result of the scattered light detector 4 or the detection result of the transmitted light detector 8. This structure can feed back, to the focal point varying part 17, at least one of information on the scattered light obtained by the scattered light detector 4 or information on the transmitted light obtained by the transmitted light detector 8. Since this can collect the second laser light according to a three-dimensional shape of the protrusions 31c and intensively provide the protrusions 31c with high energy, the protrusions 31c can be effectively removed.

### [Modifications]

Although Embodiment 5 describes application of Embodiment 4, Embodiment 5 is not limited to this. Embodiment 5 is applicable to, for example, Embodiment 1 to which the transmitted light detector 8 is added, and Embodiments 2 and 3.

Embodiments and modifications can be freely combined, and appropriately modified or omitted.

A summary of various aspects of the present disclosure will be hereinafter described as Appendixes.

### Appendix 1

A manufacturing apparatus for a semiconductor device, comprising:
a stage on which a semiconductor component is disposed with at least a part of a second main surface being exposed, the semiconductor component including a semiconductor substrate and an epitaxial layer on the semiconductor substrate, and having a first main surface of the epitaxial layer opposite to the semiconductor substrate, and the second main surface of the semiconductor substrate opposite to the epitaxial layer;
a laser oscillation device configured to irradiate the second main surface of the semiconductor component disposed on the stage with a first laser light and a second laser light higher in output than the first laser light;
a scattered light detector to detect scattered light scattered by a polycrystalline protrusion in the first laser light when the second main surface of the semiconductor component has the protrusion; and
a laser controller to cause the laser oscillation device to irradiate the protrusion with the second laser light, based on a detection result of the scattered light detector.

### Appendix 2

The manufacturing apparatus according to appendix 1,
wherein the laser oscillation device is one laser oscillator configured to irradiate the second main surface of the semiconductor substrate selectively with the first laser light and the second laser light, in an angle range of angles at which quantities of the first laser light and the second laser light entering the semiconductor component from the second main surface are lower than or equal to a predefined value.

### Appendix 3

The manufacturing apparatus according to appendix 2,
wherein the scattered light detector does not detect light reflected from the second main surface without the protrusion, the light being included in the first laser light.

### Appendix 4

The manufacturing apparatus according to appendix 1,
wherein the laser oscillation device includes:
a first laser oscillator configured to irradiate the second main surface with the first laser light; and
a second laser oscillator configured to irradiate the protrusion with the second laser light, in parallel with irradiation of the first laser light by the first laser oscillator.

### Appendix 5

The manufacturing apparatus according to any one of appendixes 1 to 4, further comprising
a transmitted light detector to detect transmitted light that has transmitted the semiconductor component in the second laser light,
wherein the laser controller changes outputs of the first laser light and the second laser light, based on the detection result of the scattered light detector and a detection result of the transmitted light detector.

### Appendix 6

The manufacturing apparatus according to appendix 5,
wherein the laser oscillation device is configured to change wavelengths of the first laser light and the second laser light, and
the laser controller performs multivariate analysis on the detection result of the scattered light detector and the detection result of the transmitted light detector for each of the wavelengths to identify at least one of a size, a shape, or a crystalline state of the protrusion.

### Appendix 7

The manufacturing apparatus according to any one of appendixes 1 to 6,
wherein the stage is configured to perform translational motion and rotate, together with the disposed semiconductor component,
the manufacturing apparatus further comprising:
an edge sensor to detect a notch provided on the semiconductor component, and an edge of the semiconductor component when the semiconductor component is disposed on the stage; and
a stage controller to control the translational motion and the rotation of the stage on which the semiconductor component is disposed, based on a detection result of the edge sensor.

### Appendix 8

The manufacturing apparatus according to appendix 5 or 6,
wherein the laser oscillation device irradiates the protrusion with the second laser light through one lens selected from among a plurality of lenses with different numerical apertures,
the manufacturing apparatus further comprising
a focal point varying part to vary a focal length of the one lens to be used for irradiation of the second laser light, based on at least one of the detection result of the scattered light detector or the detection result of the transmitted light detector.

### Appendix 9

The manufacturing apparatus according to any one of appendixes 1 to 8,
wherein the semiconductor substrate is a silicon carbide wafer, and
the second main surface is a c-face of the silicon carbide wafer.

### Appendix 10

A method of manufacturing a semiconductor device, comprising:
forming a semiconductor component including a semiconductor substrate and an epitaxial layer on the semiconductor substrate, the semiconductor component having a first main surface of the epitaxial layer opposite to the semiconductor substrate, and a second main surface of the semiconductor substrate opposite to the epitaxial layer;
disposing the semiconductor component on a stage with at least a part of the second main surface being exposed;
irradiating the second main surface of the semiconductor component disposed on the stage with a first laser light;
detecting scattered light scattered by a polycrystalline protrusion in the first laser light when the second main surface has the protrusion; and
irradiating the protrusion with a second laser light based on a detection result of the scattered light, the second laser light being higher in output than the first laser light.

While the invention has been shown and described in detail, the foregoing description is in all aspects illustrative and not restrictive. It is therefore understood that numerous modifications and variations can be devised without departing from the scope of the invention.

What is claimed is:

1. A manufacturing apparatus for a semiconductor device, comprising:
a stage on which a semiconductor component is disposed with at least a part of a second main surface being exposed, the semiconductor component including a semiconductor substrate and an epitaxial layer on the semiconductor substrate, and having a first main surface of the epitaxial layer opposite to the semiconductor substrate, and the second main surface of the semiconductor substrate opposite to the epitaxial layer;
a laser oscillation device configured to irradiate the second main surface of the semiconductor component disposed on the stage with a first laser light and a second laser light higher in output than the first laser light;
a scattered light detector to detect scattered light scattered by a polycrystalline protrusion in the first laser light when the second main surface of the semiconductor component has the protrusion; and
a laser controller to cause the laser oscillation device to irradiate the protrusion with the second laser light, based on a detection result of the scattered light detector.

2. The manufacturing apparatus according to claim 1,
wherein the laser oscillation device is one laser oscillator configured to irradiate the second main surface of the semiconductor substrate selectively with the first laser light and the second laser light, in an angle range of angles at which quantities of the first laser light and the second laser light entering the semiconductor component from the second main surface are lower than or equal to a predefined value.

3. The manufacturing apparatus according to claim 2,
wherein the scattered light detector does not detect light reflected from the second main surface without the protrusion, the light being included in the first laser light.

4. The manufacturing apparatus according to claim 1,
wherein the laser oscillation device includes:
a first laser oscillator configured to irradiate the second main surface with the first laser light; and
a second laser oscillator configured to irradiate the protrusion with the second laser light, in parallel with irradiation of the first laser light by the first laser oscillator.

5. The manufacturing apparatus according to claim 1, further comprising
a transmitted light detector to detect transmitted light that has transmitted the semiconductor component in the second laser light,
wherein the laser controller changes outputs of the first laser light and the second laser light, based on the detection result of the scattered light detector and a detection result of the transmitted light detector.

6. The manufacturing apparatus according to claim 5,
wherein the laser oscillation device is configured to change wavelengths of the first laser light and the second laser light, and
the laser controller performs multivariate analysis on the detection result of the scattered light detector and the detection result of the transmitted light detector for each of the wavelengths to identify at least one of a size, a shape, or a crystalline state of the protrusion.

7. The manufacturing apparatus according to claim 1,
wherein the stage is configured to perform translational motion and rotate, together with the disposed semiconductor component,
the manufacturing apparatus further comprising:
an edge sensor to detect a notch provided on the semiconductor component, and an edge of the semiconductor component when the semiconductor component is disposed on the stage; and
a stage controller to control the translational motion and the rotation of the stage on which the semiconductor component is disposed, based on a detection result of the edge sensor.

8. The manufacturing apparatus according to claim 5,
wherein the laser oscillation device irradiates the protrusion with the second laser light through one lens selected from among a plurality of lenses with different numerical apertures,
the manufacturing apparatus further comprising
a focal point varying part to vary a focal length of the one lens to be used for irradiation of the second laser light, based on at least one of the detection result of the scattered light detector or the detection result of the transmitted light detector.

9. The manufacturing apparatus according to claim 1,
wherein the semiconductor substrate is a silicon carbide wafer, and
the second main surface is a c-face of the silicon carbide wafer.

10. A method of manufacturing a semiconductor device, comprising:
forming a semiconductor component including a semiconductor substrate and an epitaxial layer on the semiconductor substrate, the semiconductor component having a first main surface of the epitaxial layer opposite to the semiconductor substrate, and a second main surface of the semiconductor substrate opposite to the epitaxial layer;
disposing the semiconductor component on a stage with at least a part of the second main surface being exposed;
irradiating the second main surface of the semiconductor component disposed on the stage with a first laser light;
detecting scattered light scattered by a polycrystalline protrusion in the first laser light when the second main surface has the protrusion; and
irradiating the protrusion with a second laser light based on a detection result of the scattered light, the second laser light being higher in output than the first laser light.
